(19) United States
(12) Patent Application Publication
(10) Pub. No.: US 2020/0223177 A1
(43) Pub. Date: Jul. 16, 2020

(54) ANTIMICROBIAL STRUCTURE AND METHOD FOR MANUFACTURING THE SAME

(71) Applicant: CATCHER TECHNOLOGY CO., LTD., Tainan City (TW)

(72) Inventors: CHIA-HUNG CHANG, Hsinchu City (TW); Shih-Wei Lee, Tainan City (TW); HAN-CHOU LIAO, Yunlin County (TW)

(21) Appl. No.: 16/428,036

(22) Filed: May 31, 2019

(30) Foreign Application Priority Data
Jan. 11, 2019 (TW) 108101221

(51) Int. Cl. B32B 5/26; D01D 5/00

(52) U.S. Cl. CPC B32B 5/26; D01D 5/0007; B32B 2262/02; D10B 2401/13; B32B 2255/205; B32B 2307/7145; B32B 2255/02

(57) ABSTRACT

An antimicrobial structure and a method for manufacturing the same are provided. The antimicrobial structure includes a plurality of antimicrobial layers and at least one mid layer. The antimicrobial layers are stacked together. Each of the antimicrobial layers is formed by an antimicrobial metal coated polymer fiber or antimicrobial metal fiber. The at least one mid layer is disposed between the antimicrobial layers.

### CROSS-REFERENCE TO RELATED PATENT APPLICATION

This application claims the benefit of priority to Taiwan Patent Application No. 108101221, filed on Jan. 11, 2019. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an antimicrobial structure, and more particularly to a polymer fiber based antimicrobial structure and a method for manufacturing the same.

### BACKGROUND OF THE DISCLOSURE

In daily life, people are inevitably exposed to a variety of microorganisms such as bacteria and fungi. Some of harmful microorganisms will quickly grow and propagate under suitable environmental conditions, and this may cause diseases and harm human health. Various daily necessities are usual mediums for the propagation and spread of these harmful microorganisms. In recent years with the improvement of people's living standard, antimicrobial materials have been gradually applied to daily necessities to reduce the propagation of microorganisms.

Currently, two types of materials, which are respectively metal and photocatalytic materials, are commonly used to serve as antimicrobial materials. Common metal antibacterial materials include copper, zinc and silver, the main antimicrobial mechanism of which is described as follows. Said metal antibacterial materials can release metal ions having antimicrobial ability, and the metal ions can be firmly absorbed by microorganisms with negative charges while contacting their cell membranes, so as to pass through the cell membranes to react with sulfhydryl groups on proteins in the microorganisms. Therefore, the proteins would lose their activities to cause cell death due to the loss of the division and proliferation abilities. Common photocatalytic antibacterial materials include titanium dioxide and zinc oxide, the main antimicrobial mechanism of which is described as follow. Said photocatalytic antibacterial materials can produce hydroxyl free radicals having strong oxidation ability under the irradiation of sunlight and ultraviolet rays. Said hydroxyl free radicals can destroy the microbial cell membranes to cause the loss of cytoplasm and oxidize the nucleus. Although said antibacterial materials can provide a sterilizing function, their applications still have room for improvement.

### SUMMARY OF THE DISCLOSURE

In response to the above-referenced technical inadequacies, the present disclosure provides an antimicrobial structure, which can balance light-weight, structural strength and antimicrobial ability, and a method for manufacturing the same.

In one aspect, the present disclosure provides a method for manufacturing an antimicrobial structure including the following steps. The first step is providing a composite polymer fiber and forming the composite polymer fiber into a layered structure. The composite polymer fiber has an antimicrobial metal precursor uniformly distributed thereon. The next step is reducing the antimicrobial metal precursor to antimicrobial metal so as to form the layered structure into an antimicrobial layer. The next step is providing an organic polymer fiber and forming the organic polymer fiber into a mid layer. Finally, the above two or three steps can be repeated.

In one aspect, the present disclosure provides an antimicrobial structure including a plurality of antimicrobial layers and at least one mid layer. The antimicrobial layers are stacked together. Each of the antimicrobial layers is formed by an antimicrobial metal coated polymer fiber. The at least one mid layer is disposed between the antimicrobial layers.

In one aspect, the present disclosure provides an antimicrobial structure including a plurality of antimicrobial layers and at least one mid layer. The antimicrobial layers are stacked together, wherein each of the antimicrobial layers is formed by an antimicrobial metal fiber. The at least one mid layer is disposed between the antimicrobial layers.

One of the advantages of the present disclosure is that, the antimicrobial structure, in which the at least one mid layer is disposed between the antimicrobial layers and each of the antimicrobial layers is formed by an antimicrobial metal coated polymer fiber or antimicrobial metal fiber, can provide a long-term and stable antimicrobial effect and reduce costs.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a schematic view of an antimicrobial structure according to first and second embodiments of the present disclosure.

FIG. 2 is an enlarged view of part II of FIG. 1.

FIG. 3 is an enlarged view of III of FIG. 1.

FIG. 4 is a schematic view showing a portion of an antimicrobial metal coated polymer fiber as shown in FIG. 2.

FIG. 5 is another schematic view of the antimicrobial structure according to the first and second embodiments of the present disclosure.

FIG. 6 is a schematic view showing a manufacturing process of an antimicrobial layer of the antimicrobial structure according to the first and second embodiments of the present disclosure.

FIG. 7 is a schematic view showing a portion of a composite polymer fiber as shown in FIG. 6.

FIG. 8 is a schematic view showing another manufacturing process of the antimicrobial layer of the antimicrobial structure according to the first and second embodiments of the present disclosure.

FIG. 9 is a schematic view showing a manufacturing process of a mid layer of the antimicrobial structure according to the first and second embodiments of the present disclosure.

FIG. 10 is a schematic view showing an application of the antimicrobial structure according to the first and second embodiments of the present disclosure.

FIG. 11 is a schematic view showing another application of the antimicrobial structure according to the first and second embodiments of the present disclosure.

FIG. 12 is an enlarged view of XII of FIG. 1.

FIG. 13 is another schematic view showing a portion of the composite polymer fiber as shown in FIG. 6.

FIG. 14 is a schematic view of the antimicrobial structure according to a third embodiment of the present disclosure.

FIG. 15 is a schematic view showing a manufacturing process of the antimicrobial layer of the antimicrobial structure according to the third embodiment of the present disclosure.

### DETAILED DESCRIPTION OF THE EXEMPLARY EMBODIMENTS

In recent years, there are many harmful microorganisms such as bacteria and fungi in people's living space due to the changes of lifestyle and the high-density living environment. In particular, harmful microorganisms are easily propagated under hot and humid climatic conditions in Taiwan. Thus, more and more daily necessities are required to have antibacterial ability to reduce the growth and propagation of harmful microorganisms, so as to maintain human health. Therefore, the present disclosure provides an antimicrobial structure which can be applied on various antimicrobial products and provide a long-lasting and stable antibacterial effect. Said antimicrobial product can be a filter for use in home appliances, a clothing or cloth product with antibacterial function, or a window product of a ventilated door.

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

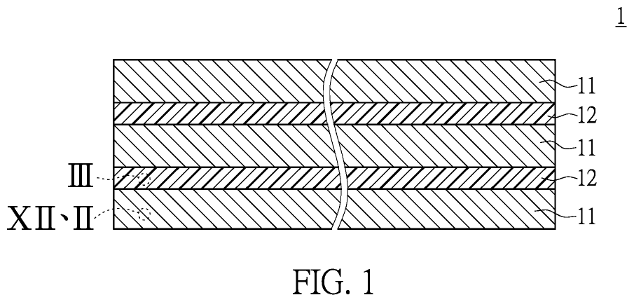

Referring to FIG. 1, a first embodiment of the present disclosure provides an antimicrobial structure 1 which includes a plurality of antimicrobial layers 11 and at least one mid layer 12. The antimicrobial layers 11 are stacked together and the at least one mid layer 12 is disposed between the antimicrobial layers 11.

Although FIG. 1 shows three antimicrobial layers 11 and two mid layers 12 and each of the mid layers 12 is disposed between the two adjacent antimicrobial layers 11, the number and the positional relationship of the heat-dissipating and mid layers 11, 12 can be changed depending on particular requirements and there is no particular limitation thereto. In the present embodiment, the thickness of the antimicrobial layer 11 can be from 0.1 μm to 100 μm and the thickness of the mid layer 12 can be from 0.1 μm to 100 μm, but are not limited thereto.

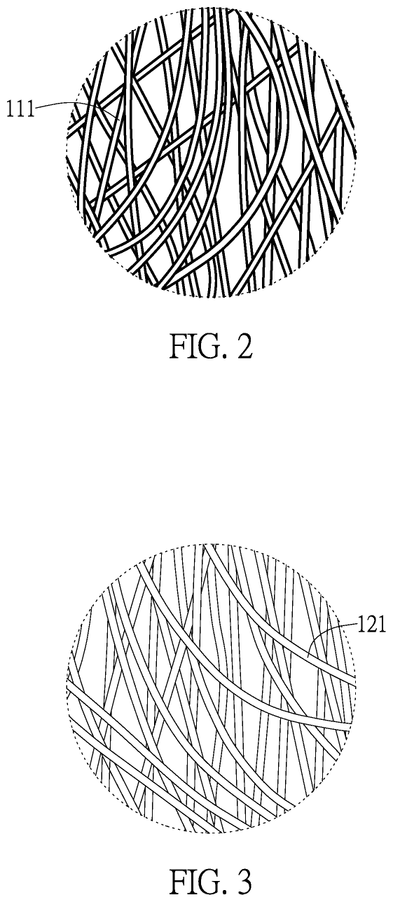

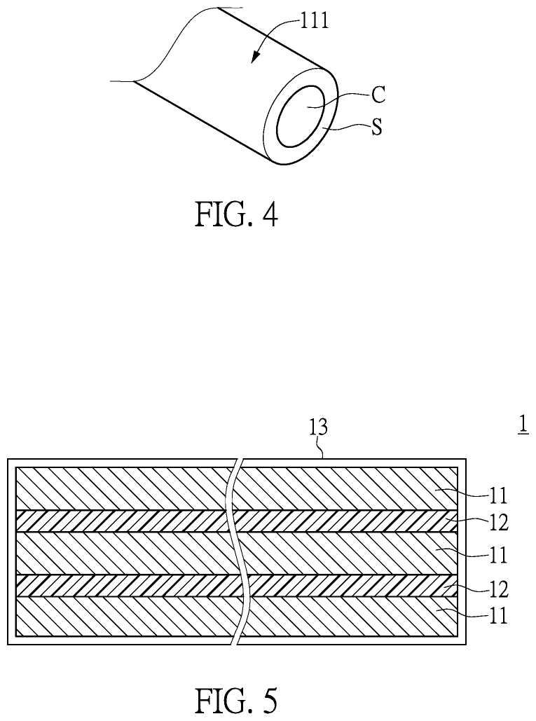

Referring to FIG. 2 in conjunction with FIG. 4, the antimicrobial layer 11 is formed by an antimicrobial metal coated polymer fiber 111. For example, one or more antimicrobial metal coated polymer fibers 111 may be closely stacked, wound or interlaced in specific directions to form the antimicrobial layer 11. Specifically, the antimicrobial metal coated polymer fiber 111 includes a polymer core C and an antimicrobial metal sheath S surrounding the polymer core C. The polymer core C has good mechanical strength to provide a support function. The antimicrobial metal sheath S has a high surface area to increase the heat absorption and release rates. The outer diameter of the polymer core C can be from 1 nm to 10000 nm and the thickness of the antimicrobial metal sheath S can be from 1 nm to 10000 nm, but are not limited thereto. Although FIG. 4 shows that the antimicrobial metal is in the form of a tubular sheath, in other embodiments, the antimicrobial metal may be in the form of fine particles that are continuously distributed on the surface of the polymer core C.

In the present embodiment, the polymer core C can be made from an acrylic, vinyl, polyester or polyamide polymer or copolymers thereof. The acrylic polymer can be, for example, polymethyl methacrylate (PMMA) or polyacrylonitrile (PAN). The vinyl polymer can be, for example, polystyrene (PS) or polyvinyl acetate (PVAc). The polyester polymer can be, for example, polycarbonate (PC), polyethylene terephthalate (PET), or polybutylene terephthalate (PBT). The polyamide polymer can be, for example, nylon. However, these are merely examples and not meant to limit the instant disclosure. In consideration of mechanical properties and processability, the polymer core C is preferably made from highly crystalline polyethylene terephthalate, polymethyl methacrylate having a low softening temperature or polystyrene having a low softening temperature, but is not limited thereto. In addition, the antimicrobial metal sheath S can be made from gold, silver, copper, platinum or alloys thereof, but is not limited thereto.

Referring to FIG. 3, in the present embodiment, the mid layer 12 can be formed by an organic polymer fiber 121. For example, one or more pieces of the antimicrobial metal coated polymer fiber 111 may be closely stacked, wound or interlaced in specific directions to form the mid layer 12. The outer diameter of the organic polymer fiber 121 can be from 1 nm to 10000 nm. The organic polymer fiber 121 can be made from an acrylic, vinyl, polyester or polyamide polymer or copolymers thereof. The specific examples have been described above and will not be reiterated herein.

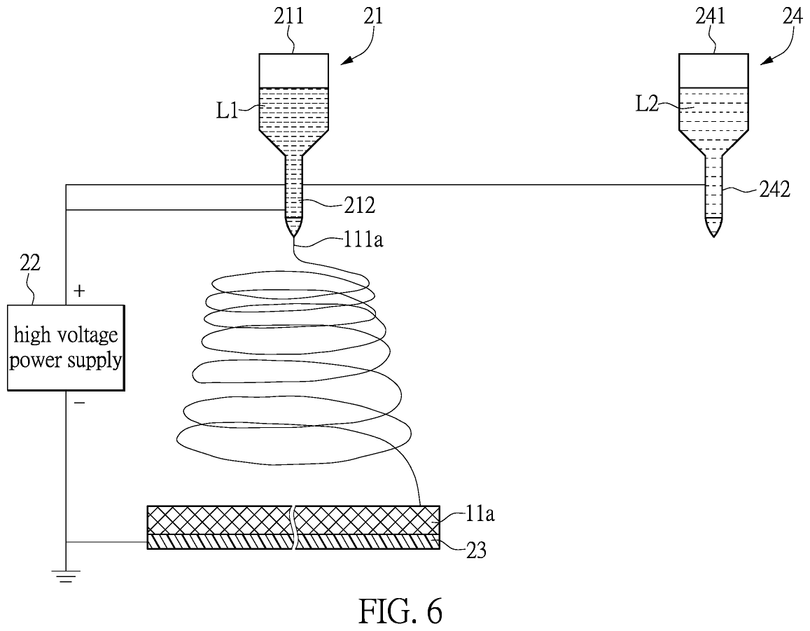

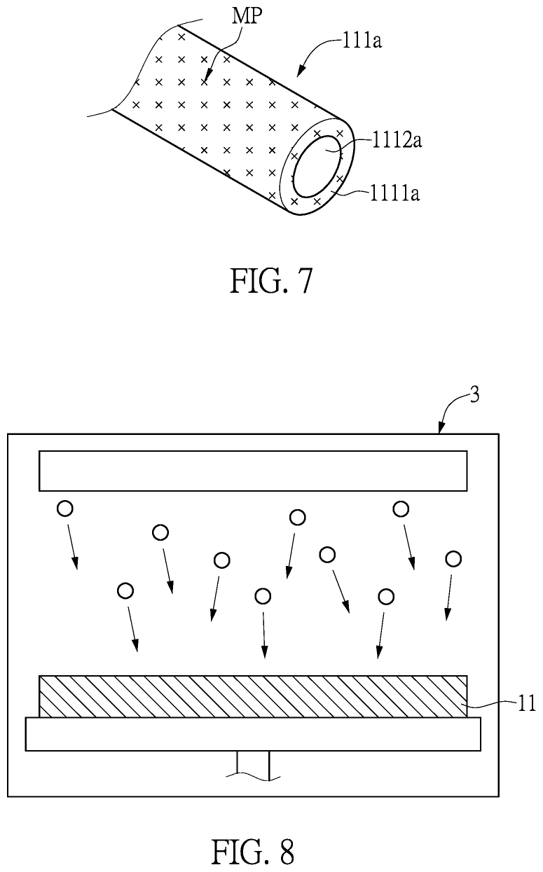

Referring to FIG. 5, the antimicrobial structure 1 can further includes a carrier 13 for carrying the antimicrobial layers 11 and the mid layer 12. The antimicrobial structure 1 can be applied on various antimicrobial products via the carrier 13. In the present embodiment, the carrier 13 can be a fixing frame, but is not limited thereto. The antimicrobial layers 11 together with the mid layer 12 can be processed to a predetermined size to be fixed in position on the carrier 13, and subsequently be installed a desired position by the carrier 13. Reference is made to FIG. 6 to FIG. 9 and the following will describe a method for manufacturing the antimicrobial structure 1. Firstly, a composite polymer fiber 111a is provided and formed into a layered structure lla. The composite polymer fiber 111a includes a core layer 1111a and a surface layer 1112a covering the core layer 1111a. It should be noted that the surface layer 1112a has an antimicrobial metal precursor MP continuously and uniformly distributed in an axial direction therein, as shown in FIG. 7. In the present embodiment, the composite polymer fiber 111a can be provided by an electrospinning device 2. The electrospinning device 2 can include a first fiber spinning unit 21, a high voltage power supply 22 and a collecting board 23. The first spinning unit 21 can include a first liquid storage tank 211 and a first spinning nozzle 212. The first spinning nozzle 212 is in fluid communication with the bottom of the first liquid storage tank 211. The high voltage power supply 22 has positive and negative outputs that are electrically connected to the first spinning nozzle 212 and the collecting board 23, respectively.

More specifically, a first electrospinning liquid L1 can be prepared and placed in the first liquid storage tank 211 of the first spinning unit 21. The first electrospinning liquid L1 includes an organic polymer, an antimicrobial metal precursor and an organic solvent. After that, an electric field with a predetermined intensity is generated between the first spinning unit 21 and the collecting board 23 by the high voltage power supply 22, such that the first electrospinning liquid L1 is ejected from the first nozzle 212 and is formed into a composite polymer fiber 111a that is deposited on the collecting board 23. It should be noted that, if the antimicrobial structure 1 includes a carrier 13, the carrier 13 can be placed on the collecting plate 23 before providing the composite polymer fiber 111a.

Although FIG. 7 shows that the composite polymer fiber 111a is formed by electrospinning, in other embodiments, the composite polymer fiber 111a can be formed by other processes such as flash spinning, electrospray, melt blown and electrostatic melt blown processes. In the present embodiment, the organic polymer is the same as the material of the polymer core C. The antimicrobial metal precursor MP is a precursor of the metal component of the antimicrobial metal sheath S, which may be a metal salt, metal halide or metal organic complex, but is not limited thereto. The organic solvent may be methanol or butanone, but is not limited thereto. If the metal component is gold, the precursor thereof may be exemplified by gold trichloride and tetrachloroauric acid. If the metal component is silver, the precursor thereof may be exemplified by silver trifluoroacetate, silver acetate, silver nitrate, silver chloride and silver iodide. If the metal component is copper, the precursor thereof may be exemplified by copper acetate, copper hydroxide, copper nitrate, copper sulfate, copper chloride and copper phthalocyanine. If the metal component is platinum, the precursor thereof may be exemplified by Sodium hexafluoroplatinate. However, these are merely examples and not meant to limit the instant disclosure.

After the formation of the layered structure 11a based on the composite polymer fiber 111a, the antimicrobial metal precursor MP of the composite polymer fiber 111a is reduced to antimicrobial metal. Accordingly, the layered structure 11a is formed into an antimicrobial layer 11. In the present embodiment, the antimicrobial metal precursor MP of the composite polymer fiber 111a can be reduced by a plasma treating device 3, so as to form the composite polymer fiber 111a into an antimicrobial metal coated polymer fiber. More specifically, the plasma treating device 3 can perform a low pressure, high pressure or atmospheric plasma treatment and the treatment time can be from 1 second to 300 seconds. The plasma treatment can use an inert gas, air, oxygen or hydrogen plasma and be performed under in an inert gas atmosphere (e.g., argon atmosphere), nitrogen atmosphere or reducing atmosphere. The reducing atmosphere may include a mixture of hydrogen gas and nitrogen or an inert gas (e.g., argon gas), wherein the hydrogen content may be from 2% to 8%, preferably 5%. However, the operation conditions of the plasma treatment can be adjusted according to actual requirements and there is no limitation thereto. During the plasma treatment, when the antimicrobial metal formed by reduction gradually accumulates on the outer surface of the polymer inner core C to form a continuous antimicrobial metal sheath S, the polymer core C would not suffer plasma bombardment.

Although FIG. 8 shows that the antimicrobial metal precursor MP of the composite polymer fiber 111a is reduced during the plasma treatment, in other embodiments, the antimicrobial metal precursor MP can be reduced by other treatments, for example, using a strong base such as sodium hydroxide.

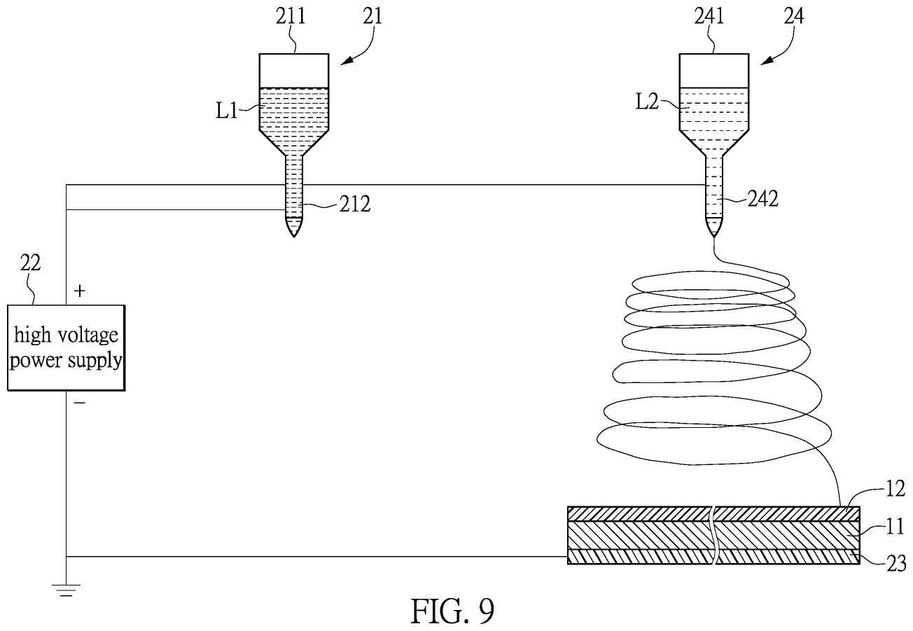

After the formation of the antimicrobial layer 11, an organic polymer fiber 121 is provided on the antimicrobial layer 11 and formed into mid layer 12. In the present embodiment, the organic polymer fiber 121 can be provided by the electrospinning device 2 as shown in FIG. 9. The electrospinning device 2 can further include a second fiber spinning unit 24. The second fiber spinning unit 24 can include a second liquid storage tank 241 and a second spinning nozzle 242 in fluid communication with the bottom of the second liquid storage tank 241. The second spinning nozzle 242 is also electrically connected to the positive output of the high voltage power supply 22.

More specifically, a second electrospinning liquid L2 can be prepared and placed in the second liquid storage tank 241 of the second spinning unit 24. The second electrospinning liquid L2 includes an organic polymer and an organic solvent. After that, an electric field with a predetermined intensity is generated between the second spinning unit 24 and the collecting board 23 by the high voltage power supply 22, such that the second electrospinning liquid L2 is ejected from the second nozzle 242 and is formed into an organic polymer fiber 121 that is deposited on the antimicrobial layer 11. In the present embodiment, the organic polymer is the same as the material of the organic polymer fiber 121 and the organic solvent may be methanol or butanone, but are not limited thereto.

Although FIG. 9 shows that the organic polymer fiber 121 is formed by electrospinning, in other embodiments, the organic polymer fiber 121 can be formed by other processes such as flash spinning, electrospray, melt blown and electrostatic melt blown processes.

It should be noted that, the above step of forming the antimicrobial layer 11 can be repeated more than once according to antimicrobial requirements. When the plurality of mid layers 12 are needed, the above step of forming the mid layers 12 can be repeated more than once.

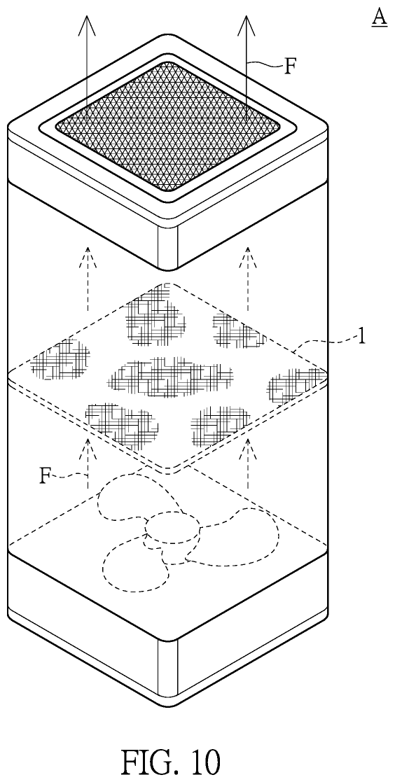

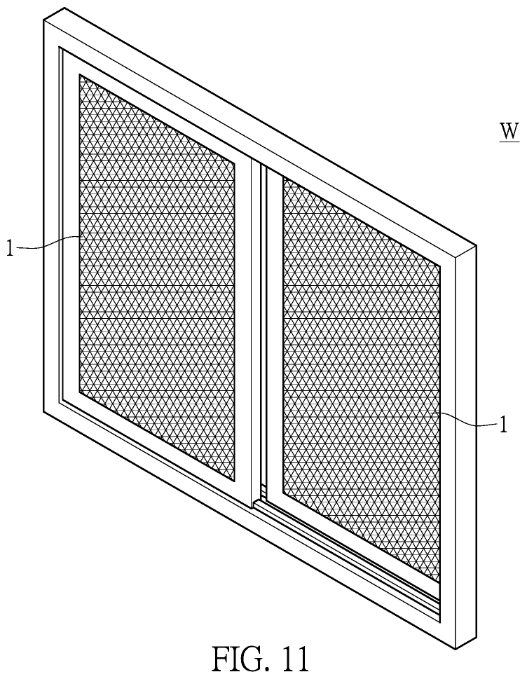

Reference is made to FIG. 10 and FIG. 11; the following will describe the applications of the present disclosure. An air purifier A, as shown in FIG. 10, can include at least one antimicrobial structure 1, and air flows F can be driven into the air purifier A by any suitable manner (e.g., fan rotation) and to the outside after being sufficiently contacting the antimicrobial structure 1, so as to purify the air. In addition, a screen window W can also include at least one antimicrobial structure 1, such that the antimicrobial structure 1 can sterilize air when the outdoor air is exchanged with the indoor air via the screen window W.

### Second Embodiment

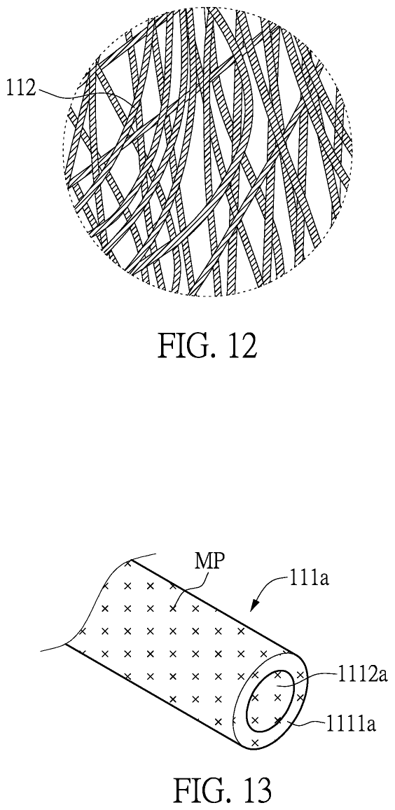

Referring to FIG. 1, which is to be read in conjunction with FIG. 12, a second embodiment of the present disclosure provides an antimicrobial structure 1 which includes a plurality of antimicrobial layers 11 and at least one mid layer 12. The antimicrobial layers 11 are stacked together and the at least one mid layer 12 is disposed between the antimicrobial layers 11. The main difference of the second embodiment from the first embodiment is that the antimicrobial layer 11 is formed by an antimicrobial metal fiber 112. For example, one or more antimicrobial metal fibers 112 may be closely stacked, wound or interlaced in specific directions to form the antimicrobial layer 11. The outer diameter of the antimicrobial metal fiber 112 can be from 1 nm to 10000 nm. The antimicrobial metal fiber 112 can be made from gold, silver, copper, platinum or alloys thereof, but is not limited thereto.

Reference is made to FIG. 6 and FIG. 7 in conjunction with FIG. 13. In the present embodiment, the method for forming the antimicrobial layer 11 firstly provides a composite polymer fiber 111a and forms the composite polymer fiber 111a into a layered structure 11a. The composite polymer fiber 111a includes a core layer 1111a and a surface layer 1112a covering the core layer 1111a. It should be noted that the core layer 1111a and the surface layer 1112a both have an antimicrobial metal precursor MP continuously and uniformly distributed in an axial direction therein, as shown in FIG. 13. The antimicrobial metal precursor MP is the same as the material of the antimicrobial metal fiber 112. After that, the antimicrobial metal precursor MP of the composite polymer fiber 111a is reduced to antimicrobial metal, so as to form the layered structure 11a into an antimicrobial layer 11. The technical details of providing the composite polymer fiber 111a and reducing the antimicrobial metal precursor MP can refer to the first embodiment, and will not be reiterated herein.

### Third Embodiment

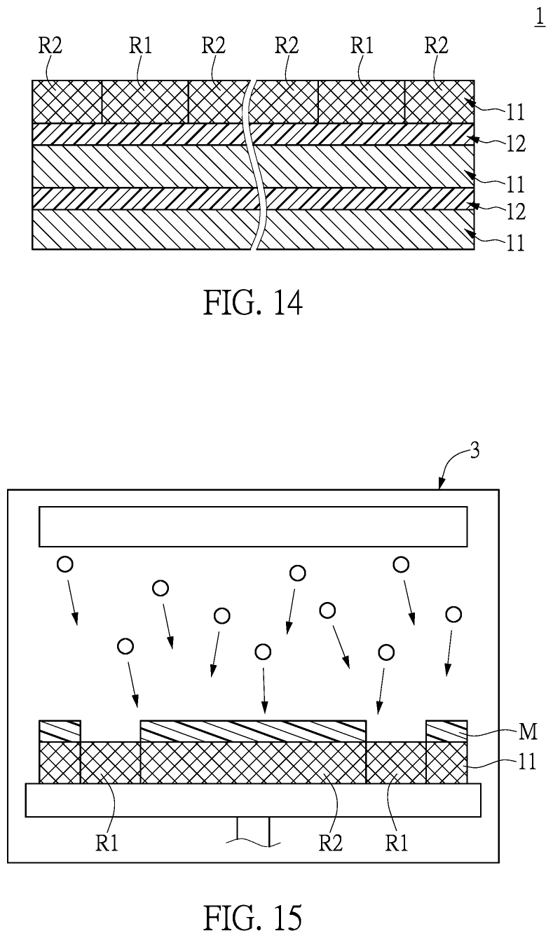

Referring to FIG. 14 and FIG. 15, a third embodiment of the present disclosure provides an antimicrobial structure 1 which includes a plurality of antimicrobial layers 11 and at least one mid layer 12. The antimicrobial layers 11 are stacked together and the at least one mid layer 12 is disposed between the antimicrobial layers 11. The main difference of the third embodiment from the above embodiments is that one of the antimicrobial layers 11 has at least one antimicrobial region R1 and a non-antimicrobial region R2 to adapt to special applications.

In the present embodiment, the method for forming the antimicrobial layer 11 firstly provides a composite polymer fiber 111a and forms the composite polymer fiber 111a into a layered structure 11a, as shown in FIG. 15. Next, a patterned mask M is formed on the layered structure 11a to expose a predetermined portion of the layered structure 11a. After that, a plasma treatment is performed on the predetermined portion of the layered structure 11a via the patterned mask M to reduce the antimicrobial metal precursor MP of the composite polymer fiber 111a of the predetermined portion to antimicrobial metal, so as to form the antimicrobial region R1. The other portion of the layered structure 11a, which is not treated with plasmas, forms the non-antimicrobial region R2.

Although FIG. 14 shows that the uppermost antimicrobial layer 11 has the antimicrobial and non-antimicrobial regions R1, R2, in other embodiments, the antimicrobial layer 11 at another location can also have the antimicrobial and non-antimicrobial regions R1, R2.

One of the advantages of the present disclosure is that the antimicrobial structure of the present disclosure, in which the at least one mid layer is disposed between the plurality of antimicrobial layers and each of the antimicrobial layers is formed by an antimicrobial metal coated polymer fiber or antimicrobial metal fiber, can provide a long-term and stable antimicrobial effect and reduce costs.

Furthermore, the antimicrobial metal coated polymer fiber includes a polymer core and an antimicrobial metal sheath surrounding the polymer core. The polymer core has good mechanical strength to provide a support function and the antimicrobial metal sheath has a high surface area to provide high antimicrobial ability. In addition, the mid layer is formed by an organic polymer fiber. Therefore, the antimicrobial structure can balance light-weight, structural strength and antimicrobial ability to meet the design requirements of the light-weight thin electronic devices.

The present disclosure further provides a method for manufacturing the antimicrobial structure, which can use a recycled metal waste liquid, is suitable for industrial mass production and can reduce resource consumption and environmental pollution.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for manufacturing an antimicrobial structure, comprising:
(A) providing a composite polymer fiber and forming the composite polymer fiber into a layered structure, wherein the composite polymer fiber has an antimicrobial metal precursor uniformly distributed thereon;
(B) reducing the antimicrobial metal precursor to antimicrobial metal so as to form the layered structure into an antimicrobial layer;
(C) providing an organic polymer fiber and forming the organic polymer fiber into a mid layer; and
(D) repeating the steps (A) and (B) or the steps (A) to (C).

2. The method according to claim 1, wherein the composite polymer fiber includes a core layer and a surface layer covering the core layer and the antimicrobial metal precursor is uniformly distributed in the surface layer, wherein the step (B) includes treating the layered structure with plasmas such that the composite polymer fiber in the layered structure is formed into an antimicrobial metal coated polymer fiber, and wherein the antimicrobial metal coated polymer fiber includes a polymer core and an antimicrobial metal sheath surrounding the polymer core.

3. The method according to claim 1, wherein the composite polymer fiber includes a core layer and a surface layer covering the core layer and the antimicrobial metal precursor is uniformly distributed in the core layer and the surface layer, and wherein the step (B) includes treating the layered structure with plasmas such that the composite polymer fiber in the layered structure is formed into an antimicrobial metal fiber.

4. The method according to claim 1, wherein the step (A) includes providing the composite polymer fiber by electrospinning and the step (C) includes providing the organic polymer fiber by electrospinning.

5. An antimicrobial structure, comprising:
a plurality of antimicrobial layers stacked together, wherein each of the antimicrobial layers is formed by an antimicrobial metal coated polymer fiber; and
at least one mid layer disposed between the antimicrobial layers.

6. The antimicrobial structure according to claim 5, wherein the antimicrobial metal coated polymer fiber includes a polymer core and an antimicrobial metal sheath surrounding the polymer core.

7. The antimicrobial structure according to claim 6, wherein the polymer core has an outer diameter between 1 nm and 10000 nm, and the polymer core is made from highly crystalline polyethylene terephthalate (PET), polymethyl methacrylate (PMMA) having a low softening temperature or polystyrene (PS) having a low softening temperature.

8. The antimicrobial structure according to claim 6, wherein the antimicrobial metal sheath has a thickness between 1 nm and 10000 nm, and the antimicrobial metal sheath is made from gold, silver, copper, platinum or alloys thereof.

9. The antimicrobial structure according to claim 5, wherein one of the antimicrobial layers has at least one antimicrobial region and a non-antimicrobial region, and the at least one antimicrobial region is made from gold, silver, copper, platinum or alloys thereof.

10. The antimicrobial structure according to claim 5, wherein the at least one mid layer is formed by an organic polymer fiber, and the organic polymer fiber is made from an acrylic, vinyl, polyester or polyamide polymer.

11. The antimicrobial structure according to claim 5, wherein the at least one mid layer is a plastic layer, and the plastic layer is made from an acrylic, vinyl, polyester or polyamide polymer.

12. The antimicrobial structure according to claim 5, further comprising a carrier for carrying the antimicrobial layers and the at least one mid layer.

13. The antimicrobial structure according to claim 5, wherein the antimicrobial layer has a thickness between 0.1 μm and 100 μm and the mid layer has a thickness between 0.1 μm and 100 μm.

14. An antimicrobial structure, comprising:
a plurality of antimicrobial layers stacked together, wherein each of the antimicrobial layers is formed by an antimicrobial metal fiber; and
at least one mid layer disposed between the antimicrobial layers.

15. The antimicrobial structure according to claim 14, wherein the antimicrobial metal fiber is made from gold, silver, copper, platinum or alloys thereof.

16. The antimicrobial structure according to claim 14, wherein the antimicrobial metal fiber has an outer diameter between 1 nm and 10000 nm.

17. The antimicrobial structure according to claim 14, wherein the at least one mid layer is formed by an organic polymer fiber, and the organic polymer fiber is made from an acrylic, vinyl, polyester or polyamide polymer.

18. The antimicrobial structure according to claim 14, wherein the at least one mid layer is a plastic layer, and the plastic layer is made from an acrylic, vinyl, polyester or polyamide polymer.

19. The antimicrobial structure according to claim 14, further comprising a carrier for carrying the antimicrobial layers and the at least one mid layer.

20. The antimicrobial structure according to claim 14, wherein the antimicrobial layer has a thickness between 0.1 μm and 100 μm and the mid layer has a thickness between 0.1 μm and 100 μm.
